(19) United States
(12) Patent Application Publication
(10) Pub. No.: US 2025/0258921 A1
(43) Pub. Date: Aug. 14, 2025

(54) System and Method for Automated Whitelisting Prior to Installation

(71) Applicant: PC Matic Inc, Sioux City, IA (US)

(72) Inventor: Jeffery A. Fleming, Knightdale, NC (US)

(73) Assignee: PC Matic Inc, SIOUX CITY, IA (US)

(21) Appl. No.: 18/437,364

(22) Filed: Feb. 9, 2024

(51) Int. Cl. G06F 21/57

(52) U.S. Cl. CPC G06F 21/572; G06F 2221/033

(57) ABSTRACT

A whitelist generator authenticates an installation file (e.g., an installation release package), parses the installation file and then for each element of the installation file, if the element is a program, the whitelist generator adds an entry in a whitelist such that after the whitelist is distributed to a target system and that program is installed on the target system, that program will be able to run on the target system.

### FIELD OF THE INVENTION

This invention relates to computer security and more particularly to a system and method for pre-whitelisting of programs.

### BACKGROUND OF THE INVENTION

Currently, when trusted software companies release a program or application, the trusted software company includes a signature. This is sometimes referred to as signing executables and/or scripts. The signature process utilizes a cryptographic process to validate the authenticity and integrity of the executables and/or scripts, including a cryptographic hash value that is used to make sure that the program or script hasn't been tampered with. Code signing implementations of the digital signature mechanism to verify the identity of the creator of the program and/or script or to identify the system that built the software and/or script. The code signing implementation includes some form of checksum to verify that the program and/or script has not been modified.

For some package distributions, for example Linux, the individual programs (e.g., executables or script files) are not signed. Instead, the installation package may be signed or protected with meta data that includes a hash or CRC that is used to verify that the entire installation package has not been tampered with. Some installers check to make sure that the installation package has not been tampered using this meta data, then installs each program in the package per the installation file. For systems that use whitelisting (or allowlisting), after the programs (e.g., executables or script files) have been installed, an administrator or IT personnel must then add each program to the whitelist. This process is tedious and error prone as often there are a large number of programs installed and for the installed application to function correctly, all or most of these programs must be added to the whitelist.

What is needed is a system and method for creating entries in a whitelist before these programs are installed.

### SUMMARY OF THE INVENTION

A whitelist generator authenticates each installation file and then, for each element of the installation file, if the element is a program, the installer creates a verified entry in a whitelist such that all installed programs will be able to run on the target system.

In one embodiment, a system for automatic generation of a whitelist for computer security is disclosed including computer instructions running on a processor opens the whitelist. The computer instructions running on the processor then reads an installation file, calculates a calculated check value for the installation file, and compares the calculated check value to a stored check value, the stored check value is within the installation file. When the calculated check value does not match the stored check value, the computer instructions terminate or continue with another installation file, otherwise, the computer instructions parse the installation file into elements and for each element, the computer instructions determine when the each element is a program and when the element is a program, the computer instructions calculate a check value for the program and adds an entry to the whitelist comprising a name of the program and the check value for the program.

In another embodiment, system for automatic generation of a whitelist for computer security is disclosed including computer instructions running on a processor opens the whitelist and read an installation release package and determines if the installation release package is valid. If the installation release package is valid, the computer instructions generate a list of install packages from the installation release package and for each install package in the list of install packages, the computer instructions running on the processor reads the install package, calculates a calculated check value for the install package, and compares the calculated check value to a stored check value, the stored check value is within the install package. If the calculated check value does not match the stored check value, the computer instructions continue with the next installation file. If the calculated check value matches the stored check value, the computer instructions parse the install package into elements and for each element, the computer instructions decompress each element and when that element is a program, the computer instructions calculate a check value for the program and adds an entry to the whitelist comprising a name of the program and the check value for the program.

In another embodiment, a method of automatic generation of a whitelist for computer security is disclosed. The method includes reading a list of installation files and for each installation file in the list of installation files: reading the installation file, calculating a calculated check value for the installation file, and comparing the calculated check value to a stored check value, the stored check value is within the installation file and when the calculated check value does not match the stored check value, continuing with a next installation file. Otherwise, parsing the installation file into elements and for each element, when that element is a program, calculating a check value for the program and adding an entry to the whitelist comprising a name of the program and the check value for the program.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates installation of an application as performed in the prior art.

FIG. 2 illustrates an installation release file.

FIG. 3 illustrates an automatic whitelist generator.

FIG. 4 illustrates the operation of a device having a whitelist generated by the automatic whitelist generator.

FIG. 5 illustrates a schematic view of a typical computer protected by a computer security system.

FIG. 6 illustrates an exemplary whitelist as created by per the present invention.

FIG. 7 illustrates an exemplary program flow of the present invention.

FIG. 8 illustrates a second exemplary program flow of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

In general, installation files include specifics of the application (e.g., version, date), a list of files to be installed and a target directory for each file, compressed versions of each file 112/114/116 to be installed, and a package signature 120 (e.g., a hash value or cyclic redundancy code-CRC). The package signature 120 is used to verify that the files are as when they were added to the installation file to guard against tampering or data errors.

Throughout this description, the term, “device” refers to any system that has a processor and runs software. Examples of such are: a personal computer, a server, a notebook computer, a tablet computer, a smartphone, a smart watch, a smart television, etc. The term, “user” refers to a human that has an interest in the device, perhaps a person (user) who is using the device.

Throughout this description, the term “directory” or “directory path” describes a hierarchical pathway to a particular folder in which files (e.g., data or programs) are stored for access by the device. For example, “C:/windows/system32” refers to files stored in a folder called “system32” which is a subfolder of another folder called “windows” which is a top-level folder of a storage device known as “C.” Note that the storage device (e.g., C:) is at times a physical device (e.g., a separate disk drive) or a logical device (e.g., a portion of a local or remote storage). Also note that the described representation (e.g., “C:/windows/system32”) is a human-readable representation of such hierarchy used by certain operating systems and any such representation is anticipated and included herein (e.g., some representations use backslashes instead of slashes).

Throughout this description, the term, “malicious software” or “malware” refers to any software having ill-intent. Many forms of malicious software are known; some that destroy data on the host computer; some that capture information such as account numbers, passwords, etc.; some that fish for information (phishing), pretending to be a known entity to fool the user into providing information such as bank account numbers; some encrypt data on the computer and hold the data at ransom, etc. A computer virus is a form of malicious software.

Throughout this document, the term program will refer to any item that potentially runs on the device, including software programs, scripts, and macros.

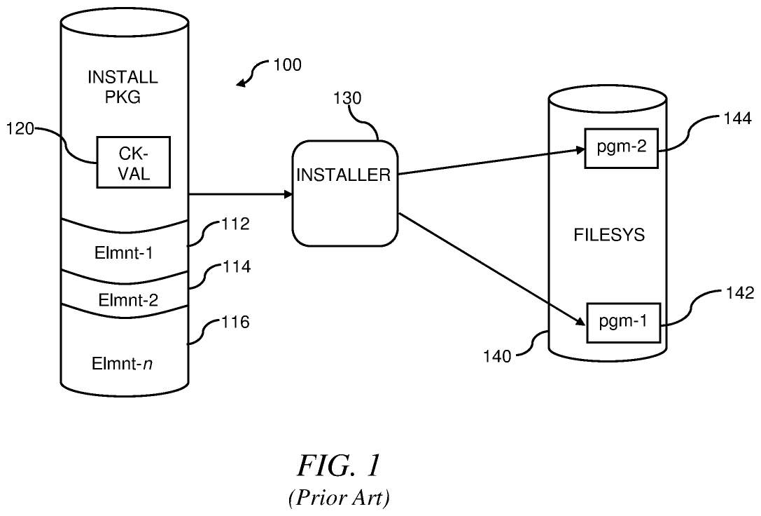

Referring to FIG. 1, installation of an application as performed by an installer 130 of the prior art is shown. In the prior art, the installation package file 100 is stored or downloaded and accessible by the installer 130 (e.g., downloaded from the Internet or provided on a removable media such as a CD-ROM or flash drive). The installation package file 100 is of a known format that is known to the installer 130 such as RPM installation files (e.g., having a .rpm suffix) and Debain installation files (having a .deb suffix).

The installer 130 reads the installation package file 100 and locates a package signature 120, according to the format of the installation package file 100 and the installer 130 makes sure that the check value matches a calculation of the same algorithm performed on the installation package file 100 (e.g., hash algorithm, checksum, CRC). This verifies that the installation package file 100 was not tampered with and has no data errors. If this verification fails, the installation is aborted and a user of the installer 130 is notified.

If the verification is successful, the installer 130 parses the installation package file 100 and decompresses and installs each element (for example, elements 112/114/116) into the location of the filesystem 140 as indicated in the installation package file 100. In this example, two of the elements 112/114/116 are programs 142/144.

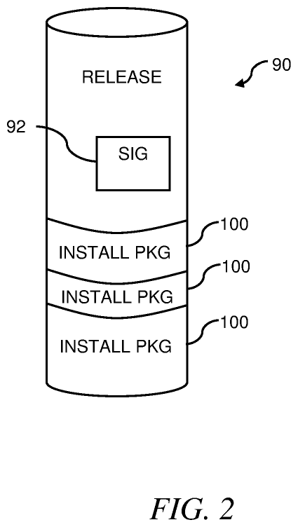

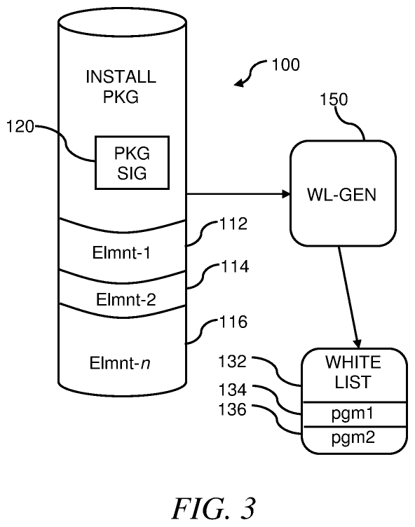

It should be noted that, in devices 10 (see FIG. 3) that are protected by security software 17 (see FIG. 2) that uses a whitelist 132 (see FIG. 2), even though each element is added that is a program, the security software will not have these programs in the whitelist 132, and these programs will not be allowed to run, even though the installation was successful. In order for these programs to run according to the prior art, each program must be individually added to the whitelist 132 which is difficult as there may be many programs and it is difficult to determine which programs were added.

In some installation scenarios, the installation package 100 is downloaded to the device 10 where the installation package 100 while in other installation scenarios, the installation package is read from the network (e.g., the Internet) and an administrator has the ability to decide which elements 112/114/116 of the installation package 100 are needed, then only those elements 112/114/116 of the installation package 100 are downloaded to the device 10 and installed.

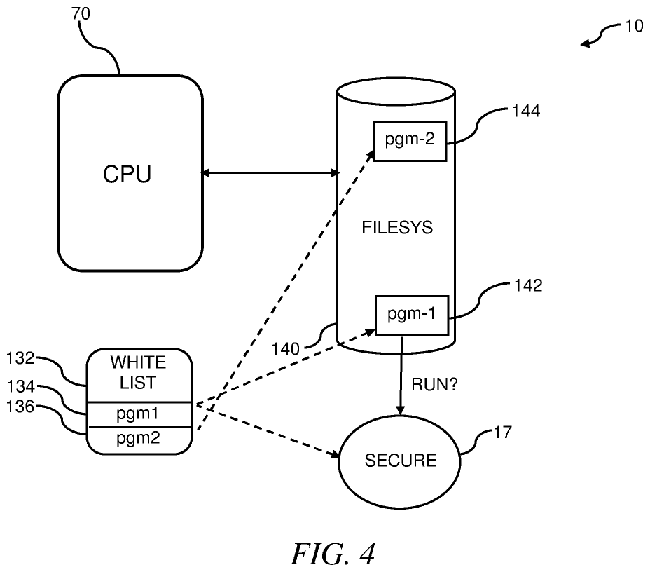

Referring to FIG. 2, a typical installation release file 90 is shown. In this, the installation release file 90 has a signature 92 and one or more installation package files 100. It is anticipated that the installation release file 90 be accessible by the device 10 (e.g., through a network) or be downloaded onto a storage of the device 10. It is anticipated that each installation package file 100 is accessible by the device 10 (e.g., through a network) or downloaded onto a storage of the device 10 and accessible by the automatic whitelist generator 150 (e.g., accessible through a network such as the Internet, downloaded from a network or provided on a removable media such as a CD-ROM or flash drive). As an example, one particular version of Linux for a certain target architecture will have an installation release file 90 that includes multiple installation package files 100, for example, an installation release file 90 for a text editor, an installation release file 90 a database, an installation release file 90 for a paint program, etc. These release files are used by the automatic whitelist generator 150 to determine which installation packages would be installed on a device 10 using the corresponding installation release file 90 so that all programs included in that installation release file 90 are properly added to the whitelist 132 (see FIG. 4). Therefore, the automatic whitelist generator 150 first makes sure the signature 92 of the installation release file 90 is valid, then the automatic whitelist generator 150 parses the installation release file 90 to extract and process each installation package file 100 that is included in the installation release file 90 as described with FIG. 3.

Referring to FIG. 3, an automatic whitelist generator 150 is shown operating on one installation package file 100 (e.g., one installation file from an installation release file 90). As there are many installation packages stored at many locations of the Internet, the automatic whitelist generator 150 is anticipated to be used for each installation package file 100 to generate a master whitelist. The installation package file 100 is of a known format that is known to an installer 130 of the prior art such as RPM installation files (e.g., having a .rpm suffix) and Debain installation files (having a .deb suffix).

The automatic whitelist generator 150 reads the installation package file 100 and locates a package signature 120, according to the format of the installation package file 100 and the automatic whitelist generator 150 makes sure that the check value matches a calculation of the same algorithm performed on the installation package file 100 (e.g., hash algorithm, checksum, CRC). This verifies that the installation package file 100 was not tampered with and has no data errors. If this verification fails, an administrator is notified and no programs in this installation package file 100 are added to the whitelist 132.

If the verification is successful, the automatic whitelist generator 150 parses the installation package file 100 and decompresses each element (for example, elements 112/114/116) and creates an entry in the whitelist 132 for each element that is a program, adding that program to the whitelist 132. For example, a first entry 134 for a first program and a second entry 136 for a second program has been added to the whitelist 132 by the automatic whitelist generator 150. Although any type or format of whitelist 132 is anticipated, as an example, the automatic whitelist generator 150 then calculates a check value 162 (see FIG. 4) for each program (e.g., a hash value or CRC value calculated from the decompressed version of the program or element) and adds a name of each program, the check value 162 for the program, and, in some embodiments, the location 164 of the program 142/144 (e.g., where the program will be stored and executed from within the filesystem 140 an in FIG. 4). In this way, when the program 142/144 requests to run, the security software 17 will look up the program 142/144 in the whitelist 132 and determine if the target location matches where the program 142/144 is stored (in embodiments that include the location 164) and that the check value 162 matches a calculated check value for the program 142/144. For example, if the program 142/144 was modified after installation, (e.g., malware was introduced), the check value 162 will not match the calculated check value for the program 142/144 and the program 142/144 will not be allowed to run (as well as any other steps to be taken by the security software 17).

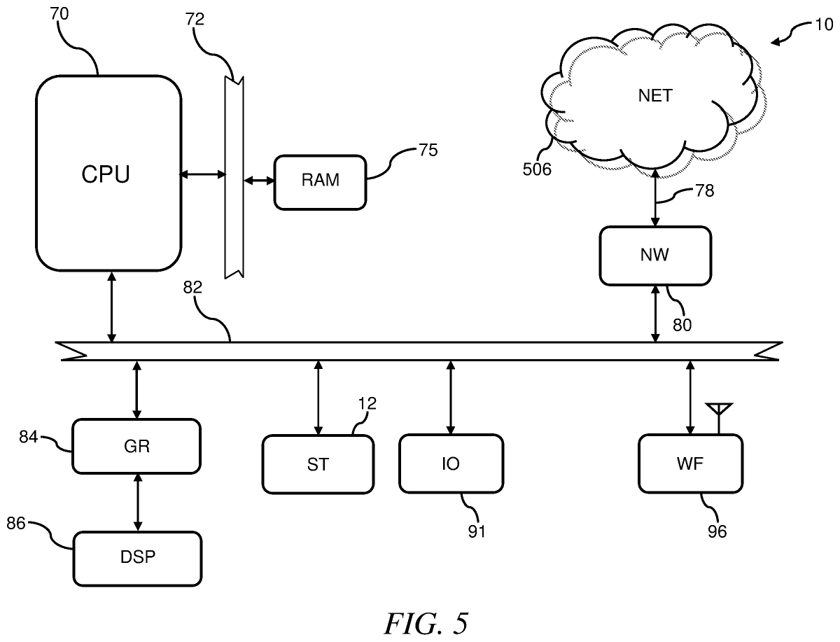

It should be noted that, in devices 10 (see FIG. 5) that are protected by security software 17 that uses a whitelist 132 (see FIG. 4), for the installed package to work properly, each program 142/144 needs to be in the whitelist 132 as created by the automatic whitelist generator 150. Otherwise, an administrator must enable operation of each program in the installed package. Therefore, after all known installation release files 90 and, therefore, all known installation package files 100 have been processed by the automatic whitelist generator 150, the whitelist 132 will have entries 134/136 for all programs that are enabled to run on all target systems and the whitelist 132 is distributed to all target systems as a master whitelist. It should be noted that other whitelists 132 such as a local whitelist are anticipated for a local administrator to enable operation of specific programs and, in the event that a specific malware is discovered in certain programs, blacklists are also anticipated that are distributed to prevent operation of those programs having malware, even though those programs having malware are in the master whitelist 132.

Referring to FIG. 4, operation of the device 10 with a whitelist 132 is described. In this, the installer 130 of the prior art has installed the first program 142 and the second program 144 into the location of the filesystem 140 as indicated in or directed by the installation package file 100. The automatic whitelist generator 150 previously generated the whitelist 132 that includes a first entry 134 that enables operation of a first program 142 and includes a second entry 136 that enables operation of a second program 144. For example, the whitelist 132 includes a first entry 134 that includes a name 160 of the first program 142, a check value 162 for the first program 142 (e.g., a hash value or CRC value calculated by the automatic whitelist generator), and, in some embodiments, the location 164 of the first program 142 within the filesystem 140. The whitelist 132 also includes a second entry 136 that includes a name 160 of the second program 144, a check value 162 for the second program 144 (e.g., a hash value or CRC value calculated by the automatic whitelist generator), and the location 164 of the second program 144 within the filesystem 140 (in embodiments that include the location 164). In this way, when the first program 142 or the second program 144 requests to run, the security software 17 will look up the program 142/144 in the whitelist 132 and determine if the check value 162 matches a run-time calculated check value for the program 142/144. For example, if the program 142/144 was modified after installation, for example, malware was introduced into the program 142/144, the check value 162 will not match the run-time calculated check value for the program 142/144 and the program 142/144 will not be allowed to run (as well as any other steps to be taken by the security software 17).

Referring to FIG. 5, a schematic view of a typical device 10 is shown representing a target device 10 or a server on which the automatic whitelist generator 150 runs (any processor-based device). The present invention is in no way limited to any particular device 10. Protection for many processor-based devices is equally anticipated including, but not limited to smart phones, cellular phones, portable digital assistants, routers, thermostats, fitness devices, smart watches etc.

The device 10 shown as an example represents a typical device on which the automatic whitelist generator 150 will run. This exemplary device 10 is shown in its simplest form. Different architectures are known that accomplish similar results in a similar fashion, and the present invention is not limited in any way to any particular computer system architecture or implementation. In this typical device 10, a processor 70 executes or runs programs in a random-access memory 75. The programs are generally stored within a persistent memory, storage 12, and loaded into the random-access memory 75 when needed. The processor 70 is any processor suitable for the device 10. The random-access memory 75 is interfaced to the processor by, for example, a memory bus 72. The random-access memory 75 is any memory suitable for connection and operation with the selected processor 70, such as SRAM, DRAM, SDRAM, RDRAM, DDR, DDR-2, etc. The storage 12 is any type, configuration, capacity of memory suitable for persistently storing data, for example, flash memory, read only memory, battery-backed memory, hard disk, etc. In some exemplary target computers 10, the storage 12 is removable, in the form of a memory card of appropriate format such as SD (secure digital) cards, micro-SD cards, compact flash, etc.

Also connected to the processor 70 is a system bus 82 for connecting to peripheral subsystems such as a network interface 80 (wired or wireless), a graphics adapter 84 and user I/O devices 91 such as mice, keyboards, touchscreens, etc. The graphics adapter 84 receives commands from the processor 70 and controls what is depicted on the display 86. The user I/O devices 91 provides navigation and selection features.

In general, some portion of the storage 12 is used to store programs, executable code, and data, the whitelist 132, etc. In some embodiments, other data is stored in the storage 12 such as audio files, video files, text messages, etc.

The peripherals shown are examples, and other devices are known in the industry such as Global Positioning Subsystems, speakers, microphones, USB interfaces, cameras, microphones, Bluetooth transceivers, Wi-Fi transceivers 96, image sensors, temperature sensors, etc., the details of which are not shown for brevity and clarity reasons.

In some embodiments, a network interface 80 connects the typical device 10 to the network 506 through any known or future protocol such as Ethernet, Wi-Fi, GSM, TDMA, LTE, etc., through a wired or wireless medium 78. There is no limitation on the type of connection used. In such, the network interface 80 provides data and messaging connections between the typical device 10 and a server computer through the network 506 for various purposes, including downloading of the installation package file 100.

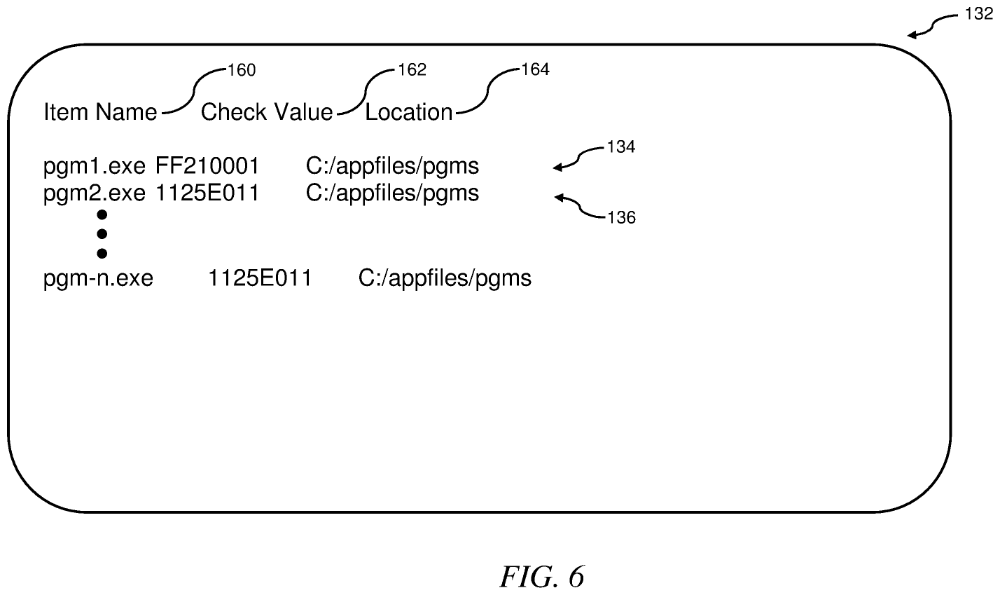

The table of FIG. 6 depicts an exemplary whitelist 132 as created by the automatic whitelist generator 150. In general, whitelists are known in the industry and are generally a list of entries, each entry describing a program (e.g., executable, script, macro) that is allowed to run on the target device 10 on which the security software 17 runs. In this way, a malicious program that is installed on the target device 10 will not be allowed to run as that malicious program does not have a valid entry in the whitelist 132 (e.g., the malicious program is blocked from running by the security software 17). Each entry in a whitelist describes the program, at least the name 160 of the program. In some embodiments, additional information is also included in the whitelist such as the location 164 of the program and a check value 162 of the program that helps assure that if the program has been tampered with, the security software 17 will prevent the program from running.

In the exemplary whitelist 132 shown in FIG. 6, there are three columns: the name 160 of the item, a check value 162, and the location 164 (optional) of the item. The name 160 of the item is the name of the program (e.g., pgm1.exe). The check value 162 is a value that is used to verify that the program has not been modified since it was installed. Although there exist many types of check values 162 that use various algorithms to calculate the check value from the program, typically the check value 162 is a hash value or a CRC value that should match a run-time calculated hash value or CRC value of the program. If it does not match the run-time calculated hash value or CRC value of the program, then it is assumed that the program was tampered with and will not be allowed to run by the security software 17. When present, the location 164 indicates where the program is stored in the file system. In the exemplary whitelist 132 shown in FIG. 4, there are several entries for programs, including a first entry 134 for the first program 142 (pgm1) and a second entry 136 for the second program 144 (pgm2) that were added to the whitelist 132 by the automatic whitelist generator 150.

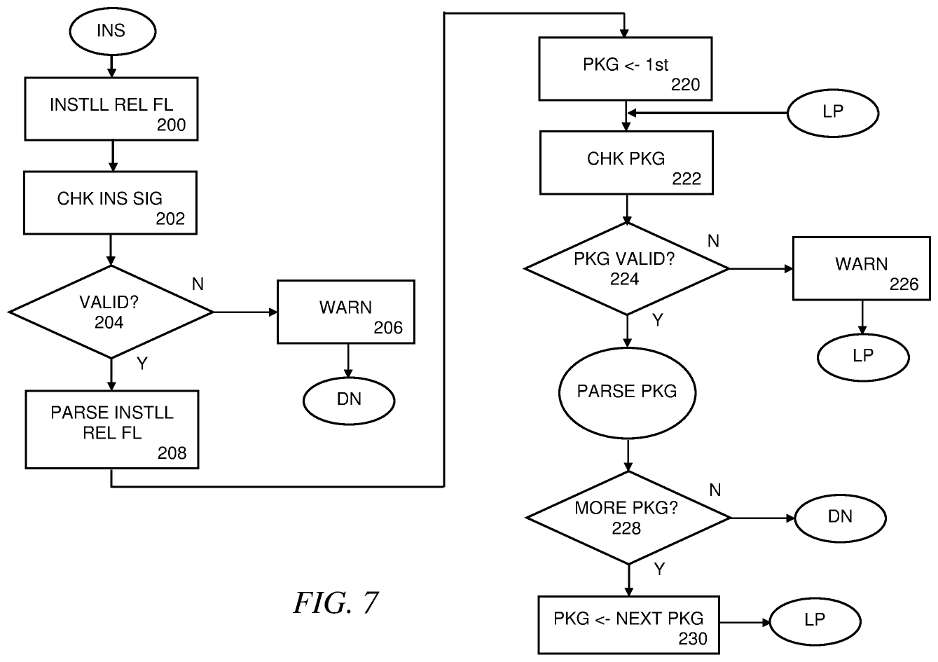

Referring to FIG. 7, an exemplary program flow of the automatic whitelist generator 150 is shown. The automatic whitelist generator 150 starts 200 by opening an installation release file 90 (e.g., accessing or downloading an installation release file 90 from a website on the Internet). The installer with automatic whitelist generator 150 checks 202 the signature 92 of the installation release file 90. If the signature 92 of the installation release file 90 is not valid, the processing of this installation release file 90 is stopped and appropriate warning 206 is made as it is assumed that this installation release file 90 is corrupt (e.g., has file errors or has been modified).

If the signature 92 of the installation release file 90 is valid, the installation release file 90 is parsed 208. The installation release file 90 typically has a set of installation package files 100, each having a package signature 120. The installer with automatic whitelist generator 150 checks 202 the signature 92 of the installation release file 90. If the signature 92 of the installation release file 90 is not valid 204, the processing of this installation release file 90 is stopped and appropriate warning 206 is made as it is assumed that this installation release file 90 is corrupt (e.g., has file errors or has been modified).

If the signature 92 of the installation release file 90 is valid 204, the automatic whitelist generator 150 accesses 220 the first installation package file 100 of the installation release file 90 as the current element. It is anticipated that the installation release file 90 will contain several installation package files 100.

The package signature 120 of the current installation package file 100 is checked 222 and if not valid 224, the processing of this installation package file 100 is stopped and appropriate warning 226 is made as it is assumed that this installation package file 100 is corrupt (e.g., has file errors or has been modified).

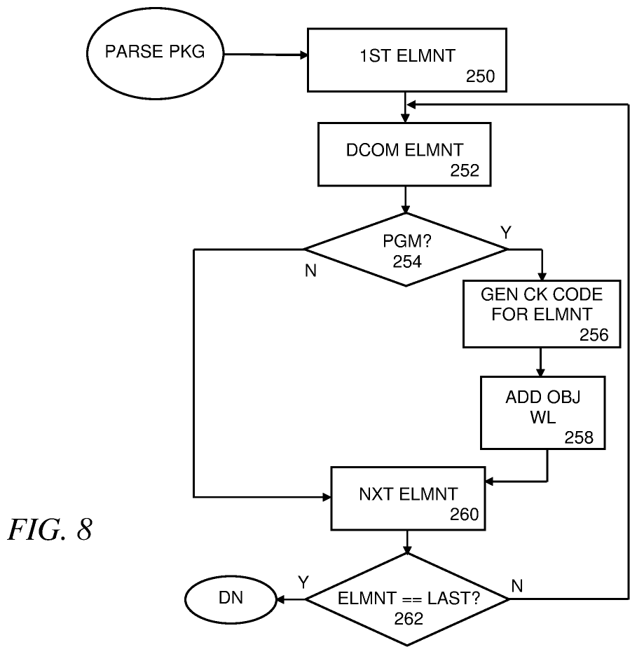

If the package signature 120 of the current installation package file 100 is valid 224 the current installation package file 100 is parsed (see FIG. 8). If there are no more 228 installation package files 100, the automatic whitelist generator 150 is done with this installation release file 90. If there are more 228 installation package files 100 within the current release installation file 90, the next installation package file 100 from the release installation file 90 is selected 230 and the above loop 222-228 continues.

Referring to FIG. 8, a second exemplary program flow of the automatic whitelist generator 150 is shown. In this, the automatic whitelist generator 150 will parse a package file 100 to create entries in the whitelist 132.

The automatic whitelist generator 150 accesses 250 the first element of the installation package file 100 as the current element.

Now, in a loop, the automatic whitelist generator 150 decompresses 252 the current element according to the instructions in the installation package file 100.

In this example, a test 254 is performed to determine if the current element is a program (e.g., some installation package files 100 include text files, fonts, etc., which are not programs and are not to be included in the whitelist 132) If the current element is a program, the automatic whitelist generator 150 then generates 256 a check code (e.g., checksum, hash, CRC) for the current element and adds 258 the current element to the whitelist 132 (e.g., adds an entry to the whitelist 132 that includes the name of the element, the check code for the element, and, optionally, the location of the element).

The next element is addressed 260. If there are no more 262 elements 260, the automatic whitelist generator 150 ends (e.g., returns to the flow of FIG. 7). If this was not the last element 260, the loop continues until all elements of the installation package file 100 are installed.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for automatic generation of a whitelist for computer security, the system comprising:
computer instructions running on a processor opens the whitelist;
the computer instructions running on the processor reads an installation file, calculates a calculated check value for the installation file, and compare the calculated check value to a stored check value, the stored check value is within the installation file; and
the computer instructions parse the installation file into elements and for each element of the elements, the computer instructions decompress the each element and when the each element is a program, the computer instructions calculate a check value for the program and adds an entry to the whitelist comprising a name of the program and the check value for the program.

2. The system for automatic generation of the whitelist for computer security of claim 1, further comprising:
until all installation files are processed, the computer instructions running on the processor reads a next installation file, calculates the calculated check value for the next installation file, and compares the calculated check value to a stored check value, the stored check value is within the next installation file;
when the calculated check value does not match the stored check value, the computer instructions stop; and
the computer instructions parse the next installation file into the elements and for the each element of the elements, the computer instructions decompresses the each element and when the each element is the program, the computer instructions calculate the check value for the program and adds another entry to the whitelist comprising the name of the program and the check value for the program.

3. The system for automatic generation of the whitelist for computer security of claim 2, further comprising:
the computer instructions save the whitelist and the computer instructions transmit the whitelist to one or more target computer systems.

4. The system for automatic generation of the whitelist for computer security of claim 3, further comprising:
after receiving the whitelist at the one or more target computer systems, security software running on each of the one or more target computer systems installs the whitelist.

5. The system for automatic generation of the whitelist for computer security of claim 4, further comprising:
after the security software running on each of the one or more target computer systems installs the whitelist, upon an attempt to run a program that is installed from the installation file on a target system of the one or more target computer systems from the installation file, the security software calculates the check value for the program and compares a name of the program and the check value for the program to an entry in the whitelist for the program and when the name of the program and the check value for the program match the entry in the whitelist for the program, the security software allows the program to run on the target system.

6. A system for automatic generation of a whitelist for computer security, the system comprising:
computer instructions running on a processor opens the whitelist;
the computer instructions read an installation release package and determines if the installation release package is valid; and
when the installation release package is valid, the computer instructions generate a list of install packages from the installation release package;
for each install package in the list of install packages:
the computer instructions running on the processor reads the install package, calculates a calculated check value for the install package, and compares the calculated check value to a stored check value, the stored check value is within the install package;
when the calculated check value does not match the stored check value, the computer instructions continue with a next installation file; and
when the calculated check value matches the stored check value, the computer instructions parse the install package into elements and for each element of the elements, the computer instructions decompress the each element and when the each element is a program, the computer instructions calculate a check value for the program and adds an entry to the whitelist comprising a name of the program and the check value for the program.

7. The system for automatic generation of the whitelist for computer security of claim 6, further comprising:
the computer instructions save the whitelist.

8. The system for automatic generation of the whitelist for computer security of claim 7, further comprising:
the computer instructions transmit the whitelist to one or more target computer systems.

9. The system for automatic generation of the whitelist for computer security of claim 8, further comprising:
after receiving the whitelist at the one or more target computer systems, security software running on each of the one or more target computer systems installs the whitelist.

10. The system for automatic generation of the whitelist for computer security of claim 9, further comprising:
after the security software running on each of the one or more target computer systems installs the whitelist, upon an attempt to run a program that was installed from the installation release package on a target system of the one or more target computer systems, the security software calculates the check value for the program and compares a name of the program and the check value for the program to an entry in the whitelist for the program and when the name of the program and the check value for the program match the entry in the whitelist for the program, the security software allows the program to run.

11. The system for automatic generation of the whitelist for computer security of claim 6, wherein the computer instructions read the installation release package after the installation release package is downloaded and stored on a storage that is operatively coupled to the processor.

12. The system for automatic generation of the whitelist for computer security of claim 6, wherein the computer instructions read the installation release package through a network that is operatively coupled to the processor.

13. The system for automatic generation of the whitelist for computer security of claim 6, wherein the computer instructions running on the processor reads the install package after the installation release package is downloaded and stored on a storage that is operatively coupled to the processor.

14. The system for automatic generation of the whitelist for computer security of claim 6, wherein the computer instructions running on the processor reads the install package through a network that is operatively coupled to the processor.

15. A method of automatic generation of a whitelist for computer security, the method comprising:
reading an installation release package and generating a list of installation files; and
for each installation file in the list of installation files:
parsing the installation file into elements and for each element of the elements, when the each element is a program, calculating a check value for the program and adding an entry to the whitelist comprising a name of the program and the check value for the program.

16. The method of claim 15, further comprising:
saving the whitelist in storage.

17. The method of claim 16, further comprising:
transmitting the whitelist to one or more target computer systems.

18. The method of claim 17, further comprising:
after receiving the whitelist at a target computer system of the one or more target computer systems, security software running on a processor of the target computer system installing the whitelist.

19. The method of claim 18, further comprising:
after the security software running on the processor of the target computer system installing the whitelist, upon an attempt to run a program that is installed from the installation file onto the target computer system, the security software calculating the check value for the program and comparing a name of the program and the check value for the program to the entry in the whitelist for the program and when the name of the program and the check value for the program matches the entry in the whitelist for the program, the security software allowing the program to run.
